(19) United States
(12) Patent Application Publication
(10) Pub. No.: US 2024/0239555 A1
(43) Pub. Date: Jul. 18, 2024

(54) BEVERAGE VESSEL WITH IDENTIFICATION MEMBERS

(71) Applicant: Tony Hui, Surrey (CA)

(72) Inventor: Tony Hui, Surrey (CA)

(21) Appl. No.: 18/153,466

(22) Filed: Jan. 12, 2023

(51) Int. Cl. B65D 23/08; G09F 23/00

(52) U.S. Cl. CPC B65D 23/0807; G09F 23/00; B65D 2203/02; G09F 2023/0025

(57) ABSTRACT

A beverage vessel with identification members wherein a user thereof can employ the identification members to create a personal identification code that is operable to indicate a user of the beverage vessel. The present invention includes a vessel body having a bottom and wall contiguously formed defining the shape thereof and creating an interior volume operable to retain and store a liquid. The wall of the vessel body has an exterior surface having present thereon a plurality of identification members. The identification members include an internal area wherein the internal area has indicia imprinted thereon. The identification members have operably coupled thereto cover members. The cover members are movable between a first position and a second position. In the second position of the cover member the internal area of the identification member is exposed. The identification members are provided in a plurality of rows and columns.

### FIELD OF THE INVENTION

The present invention relates generally to beverage containers, more specifically but not by way of limitation, a beverage vessel that is configured with a plurality of identification members wherein the identification members are movable between a first position and a second position providing customizable identification of the beverage vessel.

### BACKGROUND

Millions of plastic beverage vessels are utilized on a daily basis. Plastic water bottles and other similar types of vessels provide a convenience for storing and consuming all types of beverages such as but not limited to water. All beverage vessels will have a label secured thereto wherein the label will typically identify a manufacturer and the type of beverage. Other marketing material can also be displayed on the conventional labels.

One problem with conventional beverage vessels is identifying the person that is consuming the liquid disposed in the beverage vessel. It is very common in large gatherings that people will be drinking the same type of beverage wherein each person has an identical beverage vessel. During the course of the gathering the beverage vessels are commonly placed in various locations such as but not limited to tables and bars. As the beverage vessel are placed in various locations, it is quite common for individuals to lose track of the beverage vessel from which they were consuming. This often results in a half consumed beverage vessel being thrown out and the individual retrieving a new beverage vessel.

It is intended within the scope of the present invention to provide beverage vessel with identification members that are configurable to provide a plurality of customized identification options so as to facilitate an ability to identify a beverage vessel and a user associated therewith.

### SUMMARY OF THE INVENTION

It is the object of the present invention to provide a beverage vessel having identification members that are configurable to provide a plurality of identification options wherein the present invention includes a vessel body having an interior volume operable to receive and store a liquid.

Another object of the present invention is to provide a beverage vessel with identification members operable to distinguish the beverage vessel from other similar beverage vessels wherein the vessel body includes a wall having an exterior surface.

A further object of the present invention is to provide a beverage vessel having identification members that are configurable to provide a plurality of identification options that further includes a plurality of identification members.

Still another object of the present invention is to provide a beverage vessel with identification members operable to distinguish the beverage vessel from other similar beverage vessels wherein the identification members are disposed on the exterior surface of the wall of the vessel body.

An additional object of the present invention is to provide a beverage vessel having identification members that are configurable to provide a plurality of identification options wherein the identification members include a cover member.

Yet a further object of the present invention is to provide a beverage vessel with identification members operable to distinguish the beverage vessel from other similar beverage vessels wherein the cover member is movable to place the identification member in a first position and a second position.

Another object of the present invention is to provide a beverage vessel having identification members that are configurable to provide a plurality of identification options wherein in the second position the cover member provides exposure of an indicia.

An alternate object of the present invention is to provide a beverage vessel with identification members operable to distinguish the beverage vessel from other similar beverage vessels wherein the indicia can be numerical, letters or colors.

Still a further object of the present invention is to provide a beverage vessel having identification members that are configurable to provide a plurality of identification options wherein in a preferred embodiment of the present invention the identification members are arranged in columns and rows.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a front view of the present invention; and

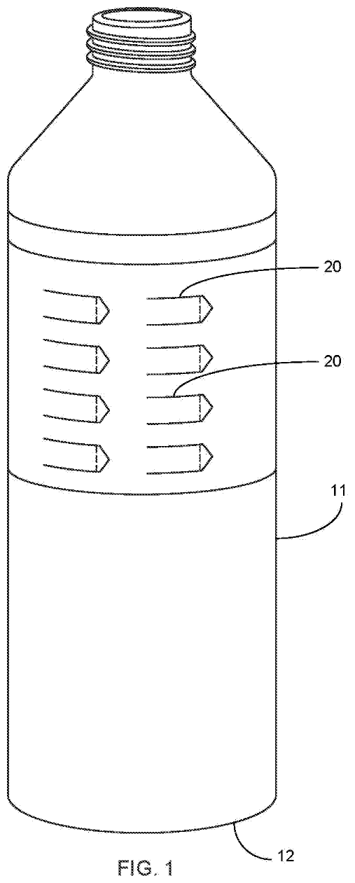

FIG. 2 is a front view of the present invention having a portion of the identification members in their second position; and

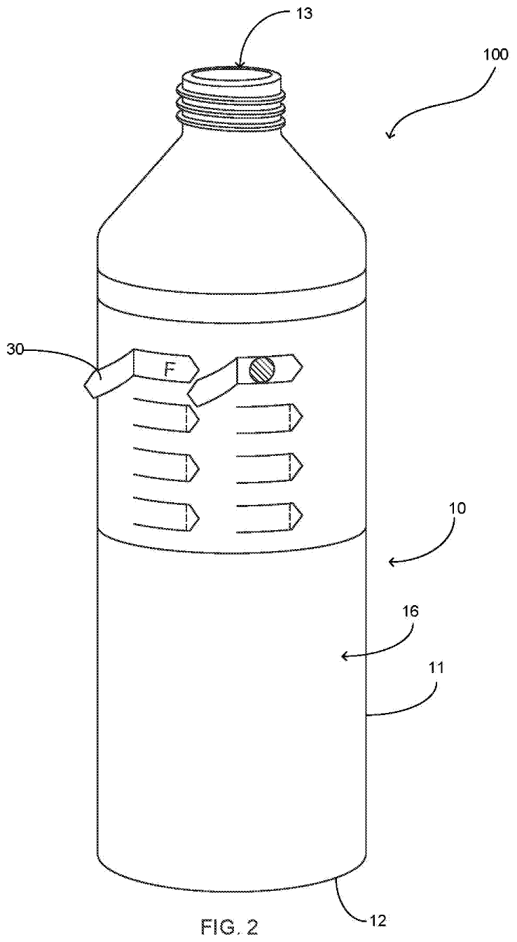

FIG. 3 is a front view of the present invention having the identification members in their second position.

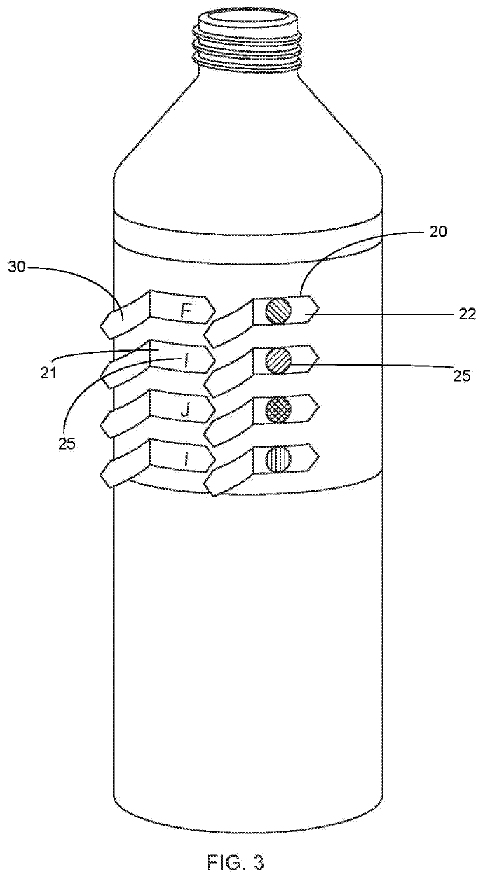

### DETAILED DESCRIPTION

Referring now to the drawings submitted herewith, wherein various elements depicted therein are not necessarily drawn to scale and wherein through the views and figures like elements are referenced with identical reference numerals, there is illustrated a beverage vessel with identification members 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring to the drawings submitted herewith, the beverage vessel with identification members 100 includes a vessel body 10. The vessel body 10 includes a wall 11 and bottom 12 forming the shape the shape thereof wherein the body has an interior volume with an opening 13 providing access thereto. It should be understood within the scope of the present invention that the vessel body 10 could be provided in many sizes and shapes and that the vessel body 10 illustrated herein is exemplary only and does not provide any limitation thereto. It is contemplated within the scope of the present invention that the vessel body 10 is manufactured from a suitable durable material such as but not limited to plastic.

Formed into the exterior surface 16 of the wall 11 are a plurality of identification members 20. The identification members 20 are formed into the exterior surface 16 utilizing suitable durable techniques. The identification members 20 are generally rectangular in shape having a pointed end 22. It should be understood within the scope of the present invention that the identification members 20 could be provided in alternate shapes and sizes. The identification members 20 include an internal area 21 wherein the indicia 25 is imprinted thereon. The indicia 25 is utilized in combination with indicia 25 on alternate identification members 20 to create a unique personal identification code so as to establish a user of the vessel body 10. The identification members 20 are provided in a plurality of rows and columns in order to provide a multitude of combinations for creation of a personal identification code. It is contemplated within the scope of the present invention that the vessel body 10 will have at least two rows of identification members 20 wherein each row would have at least two columns. While an orientation of rows and columns of the identification members 20 are provided in a preferred embodiment of the beverage vessel with identification members 100, it is contemplated within the scope of the present invention that the identification members 20 could be arranged in alternate patterns.

The identification members 20 have a cover member 30 operably coupled thereto. The cover member 30 is releasably secured to the identification member 20 and functions to provide coverage of the internal area 21. The cover member 30 is manufactured from a suitable flexible material such as but not limited to plastic. The cover member 30 has a first position and a second position. In the first position the cover member 30 is completely superposed the internal area 21 so as to conceal the indicia 25 imprinted thereon. In the second position, the cover member 30 is either removed from the identification member 20 or peeled back (as illustrated herein) so as to reveal the internal area 21 and as such the indicia 25. The user of the beverage vessel with identification members 100 utilizes the cover member 30 placing a desired pattern and/or quantity of cover members 30 in a second position so as to create a personal identification code for the purpose of identifying the user of the beverage vessel with identification members 100. It is contemplated within the scope of the present invention that the indicia 25 could be provided in a multitude of numbers, letters, symbols or colored shapes.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A beverage vessel configured to facilitate establishment of a personal identification code operable to identify a user of the beverage vessel wherein the beverage vessel comprises:
a vessel body, said vessel body having a bottom and a wall contiguously formed creating an interior volume suitable to receive and store a liquid therein, said vessel body having an opening distal to said bottom providing access to the interior volume, said wall having an exterior surface;
a plurality of identification members, said plurality of identification members being formed on the exterior surface of said wall, said plurality of identification members having an internal area, said internal area of said plurality of identification members having indicia imprinted thereon; and
a plurality of cover members, said cover members being adjacent said plurality of identification members, said cover members having a first position and a second position.

2. The beverage vessel configured to facilitate establishment of the personal identification code operable to identify the user of the beverage vessel as recited in claim 1, wherein in said first position said cover members are operable to provide coverage of the internal area of the identification members.

3. The beverage vessel configured to facilitate establishment of the personal identification code operable to identify the user of the beverage vessel as recited in claim 2, wherein in said second position said cover members are operable to provide exposure of the internal area of the identification members.

4. The beverage vessel configured to facilitate establishment of the personal identification code operable to identify the user of the beverage vessel as recited in claim 3, wherein the cover members are mateably shaped to the identification members.

5. The beverage vessel configured to facilitate establishment of the personal identification code operable to identify the user of the beverage vessel as recited in claim 4, wherein the indicia is selected from a group of one of the following: numbers, letters, symbols or colored shapes.

6. The beverage vessel configured to facilitate establishment of the personal identification code operable to identify the user of the beverage vessel as recited in claim 5, wherein the plurality of identification members are arranged in a pattern of rows and columns.

7. The beverage vessel configured to facilitate establishment of the personal identification code operable to identify the user of the beverage vessel as recited in claim 6, wherein the cover members are manufactured from a flexible plastic.
